(19) United States
(12) Patent Application Publication
(10) Pub. No.: US 2020/0351474 A1
(43) Pub. Date: Nov. 5, 2020

(54) SYSTEM AND APPARATUS FOR MAILBOX SECURITY

(71) Applicant: SafeDeliv, LLC, Mason, OH (US)

(72) Inventors: Juan Carlos Gaudiano Del Bosque, Mason, OH (US); Pranav Yenugu, Mason, OH (US)

(21) Appl. No.: 16/547,406

(22) Filed: Aug. 21, 2019

Related U.S. Application Data
(60) Provisional application No. 62/720,437, filed on Aug. 21, 2018.

(51) Int. Cl. H04N 7/18; H04N 5/225; H04N 5/76; G08B 3/10; G08B 13/196; A47G 29/122

(52) U.S. Cl. CPC H04N 7/183; H04N 5/2253; H04N 5/76; G08B 3/1016; G06F 3/041; G08B 13/1966; G08B 13/19684; G08B 13/19695; A47G 29/1225; G08B 13/19632

(57) ABSTRACT

The system and apparatus of the disclosure includes a receptacle, referred to herein as a mailbox, and a camera system for detecting and recording movement in and about the receptacle. Detected movement can include the activities of persons depositing or retrieving items from the mailbox, both authorized and unauthorized. Recorded information can include audio and video, and recorded information can be record in discrete clips or continuous streaming with time/date stamping. The camera system can additionally report activity to a remote device, such as computer, server system or a mobile device, including a cell phone, for review. Reporting can be in real time, or stored in a memory device for later review.

### CROSS-REFERENCE TO RELATED APPLICATION

The present application claims the priority of U.S. Provisional Patent Application Ser. No. 62/720,437, entitled SYSTEM AND APPARATUS FOR MAILBOX SECURITY, filed Aug. 21, 2018, and hereby incorporates the same application herein by reference in its entirety.

### TECHNICAL FIELD

Embodiments of the technology relate, in general, to mailboxes and mailbox security.

### BACKGROUND

Mailboxes for receiving mail from the United States Postal Service, as well as other receptacles for receiving and holding valuable items, can often be vulnerable to theft. Mail, such as letters and packages, are often left for extended periods after delivery before the rightful recipient can retrieve it from a mailbox. During the time that mail is sitting in a mailbox thieves can easily remove and take it. Such theft can be completely undetected and, therefore, impossible to prosecute.

Accordingly, there remains an unmet need for better security of mail deposited in mailboxes.

Further, there remains an unmet need for systems and apparatuses for enabling possible prosecution of theft of mail from mailboxes.

Additionally, there remains an unmet need for systems and apparatuses for detecting the tampering with items deposited in a receptacle by un authorized persons.

### SUMMARY

The system and apparatus of the disclosure includes a receptacle, referred to herein as a mailbox, and a camera system for detecting and recording movement in and about the receptacle. Detected movement can include the activities of persons depositing or retrieving items from the mailbox, both authorized and unauthorized. Recorded information can include audio and video, and recorded information can be record in discrete clips or continuous streaming with time/date stamping. The camera system can additionally report activity to a remote device, such as computer, server system or a mobile device, including a cell phone, for review. Reporting can be in real time, or stored in a memory device for later review.

### BRIEF DESCRIPTION OF THE DRAWINGS

The present disclosure will be more readily understood from a detailed description of some example embodiments taken in conjunction with the following figures:

FIG. 1 depicts a schematic view of a camera system according to one embodiment.

FIG. 2 depicts a schematic view of a camera system according to one embodiment.

FIG. 3 depicts a perspective view of a mailbox and camera system according to one embodiment.

FIG. 4 depicts a perspective view of a mailbox and camera system according to one embodiment.

FIG. 5 depicts a perspective view of a mailbox and camera system according to one embodiment.

FIG. 6 depicts a perspective view of a mailbox according to one embodiment.

FIG. 7 depicts a representative view of a camera internal to a mailbox for a camera system of one embodiment.

FIG. 8 depicts a representative view of a camera internal to a mailbox for a camera system of one embodiment.

### DETAILED DESCRIPTION

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Described herein are example embodiments of receptacles, including mailboxes, and related security systems and apparatuses. In example embodiments, the receptacle is a mailbox, but the invention need not be so limited. In the illustrated embodiments, a camera system including a camera and associated system components can be operably associated with a mailbox to detect and/or record unauthorized tampering with contents therein.

The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

### System and Apparatus

In general, the system and apparatus of the disclosure includes a receptacle, referred to herein as a mailbox, and a camera system for image capture, including detecting and recording movement in and about the receptacle. Detected movement can include the activities of persons depositing or retrieving items from the mailbox, both authorized and unauthorized. Recorded information can include audio and video, and recorded information can be recorded in discrete clips or in a continuous stream with time/date stamping. The camera system can additionally report activity to a remote device, such as computer, server system or a mobile device, including a cell phone, for review. Reporting can be in real time, or stored on a server or other memory device for later review.

The camera system can include a camera for both still and video capture, as well as at least one motion detector, a power source, which can be internal to the camera system or remote, non-transient memory components, processors, Bluetooth components, Wi-Fi components, a visual display and circuitry including a motherboard for operation and integration of all the various components.

The components of the camera system can be integrated into a self-contained unit that can be mounted on, in, or near a mailbox. Alternatively, any individual component, such as a camera with memory and a power supply can be mounted remotely and operatively connected. For example, a power supply in the form of a battery pack can be disposed remotely a distance from the camera, and connected electrically by wires for operation. Likewise, memory for image capture can be located remotely so that if the camera is removed (e.g., stolen), image capture can be retained in a secure, retrievable location.

### Camera

The camera used in the camera system can be any device for capturing images, both still and moving. In this respect, the camera incorporated in the camera system can be, or can incorporate technological aspects of, any of the following types of cameras: an action camera, an animation camera, an autofocus camera, a backup camera, a banquet camera, a box camera, a bridge camera, a camcorder, a camera phone, a closed-circuit television camera, a compact camera, a compact system camera, a dashcam, a digital camera, a disposable camera, a document camera, a field camera, a FireWire camera, a folding camera, a gun camera, a helmet camera, a high-speed camera, a hidden camera, an instant camera, an IP camera, a keychain camera, a light-field camera, a live-preview digital camera, a medium format camera, a mirrorless interchangeable-lens camera, a monorail camera, a movie camera, a multiplane camera, an omnidirectional camera, an onboard camera, a pinhole camera, a pinspeck camera, a plate camera, a pocket camera, a pocket video camera, a point-and-shoot camera, a Polaroid camera, a pool safety camera, a press camera, a process camera, a professional video camera, a rapatronic camera, a rangefinder camera, a red light camera, a reflex camera, a remote camera, a rostrum camera, a Schmidt camera, a single-lens reflex camera, a stat camera, a stereo camera, a still camera, a still video camera, a subminiature camera, a system camera, a thermal imaging camera, a thermographic camera, a toy camera, a traffic camera, a traffic enforcement camera, a twin-lens reflex camera, a video camera, a view camera, a webcam, a Wright camera, a Zenith camera, or a zoom-lens reflex camera.

### Motion Detector

The motion detector(s) used in the camera system can be any device for detecting motion. In this respect, the motion detector(s) incorporated in the camera system can be, or can incorporate technological aspects of, any of the following types of motion sensors: proximity sensors, infrared sensors, including passive infrared (PIR) sensors, microwave pulse sensors, dual technology motion sensors, area reflective type sensors, ultrasonic sensors, vibration sensors, and wireless motion sensors.

### Power Source

The power source used in the camera system can be any source suitable for providing operation power to the camera system. In this respect, the power source can be, or can incorporate technological aspects of, any of the following types of power and power sources: atomic energy, banki turbines, battery, batteries, battery packs, bioalcohol, biodiesel, biodiesel production, biofuel, biogas, biomass, bio-nano generator, bitumen, breeder reactor, bubble fusion (a nuclear fusion reaction hypothesized to occur during sonoluminescence, an extreme form of acoustic cavitation), coal, coal mining, cold fusion, combustion, compound turbine (e.g., two axle, steam), compressed air energy storage, solar power including concentrated solar power, deep lake water cooling, diesel, Dyson sphere, electrical grid, energy tower, external combustion engine, Fischer-Tropsch process, flywheel (storage), fossil fuel, fossil-fuel power station, Francis turbine, fuel, fuel cell, fusion power, gas turbine, gasohol, geothermal exchange heat pump, geothermal heating, geothermal power, Grid energy storage, high-altitude wind power (energy can be captured from the wind by kites, aerostats, airfoil matrices, balloons, bladed turbines, kytoon, tethered gliders sailplanes), hydroelectricity, hydrogen economy, hydrogen storage, underground hydrogen storage, hydropower, implosion, Kaplan turbine, light crude, liquid fuel, liquid nitrogen, marine current power, magnetohydrodynamic,generator ((MHD); generator or dynamo transforms thermal energy or kinetic energy directly into electricity), methane clathrate, methanol, natural gas, nuclear energy, nuclear fusion, nuclear reactor, nuclear reprocessing, oil, oil shale, osmotic power (also known as salinity gradient power, e.g., the energy available from the difference in the salt concentration between seawater and fresh water), OTEC—Ocean thermal energy conversion, oxidation, peat, perpetuum mobile, petroleum, photovoltaics, piezoelectricity, pneumatics, Products based on refined oil, propellant, pumped-storage hydroelectricity, pyrolysis, renewable energy, Savonius wind turbine, small hydro, solar box cooker, solar cell, solar chimney, solar panel, solar energy, solar power satellite, solar thermal energy, solar updraft tower, solar water heating, solid fuel, sonoluminescence (e.g., the emission of short bursts of light from imploding bubbles in a liquid when excited by sound), S STAR—small, sealed, transportable, autonomous reactor, steam turbine, Stirling engine, straight vegetable oil, stranded gas reserve fuel, sulfur-iodine cycle, synfuel, syngas, tar sands fuel, Tesla turbine, thermal depolymerization, thermal power, thorium, tidal power, transmutation, turgo turbine, i.e., impulse water turbine designed for medium head applications, Tyson turbine, i.e., for river flow harnessing, UASB, Uranium, vacuum energy, vibration energy scavenging, vortex energy, water turbine, wave power, wind energy, wind farm, wind turbine, wood fuel, wood gas, zero-point energy, and a system of contactless wireless charging where energy from a solar panel, electricity, or some other source is transferred wirelessly and without contact to a battery of the camera system.

### Power Storage

The power storage (if utilized) used in the camera system can be any source suitable for providing operation power to the camera system. In this respect, the power storage can be, or can incorporate technological aspects of, any of the following types of power and power sources: chemical battery, rechargeable battery, and hydrogen battery.

### Circuitry and Component Connections

The camera system can utilize any electronic and electrical components suitable for processing, storing, and/or transmitting signals, data, digital images, and other detected and stored information. In this respect, the circuitry and component connections associated with the camera system can include: Bluetooth components and technology, processor(s), including single core processor, non-transient memory, e.g., RAM, including 512 MB RAM, camera connectors such as wires, Wi-Fi components and technology, display(s) such as touchscreen, color, flat-screen, and flexible displays.

### Materials

The mailbox and camera system of the disclosure can utilize materials suitable for the disclosed purposes. Mailboxes and camera system components can be made of, either in whole or is part, wood, rubber, polymers, metal, leather, and organic materials. In embodiments, the mailbox and camera system can be weather resistant or weather proof.

### Mailbox

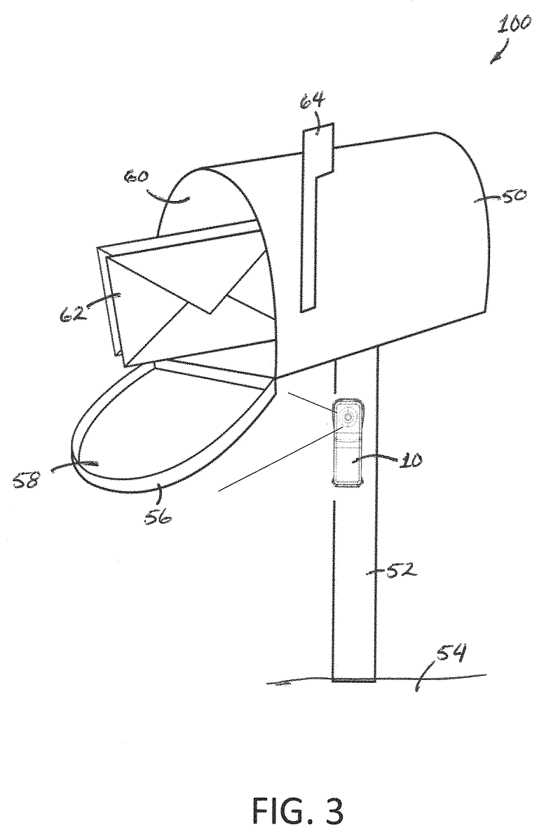

The mailbox may be any shape and size and may be made of any appropriate material. The mailbox may be supported on a dedicated support, such as a pole or a post, or it may be attached to another structure, such as a sidewall of a house. The mailbox can have a door which can be hinged to facilitate opening the mailbox for the deposit and retrieval of mail therein. The mailbox depicted herein is representative only. That is, any of various mailbox sizes, shapes, designs, and mounting means can be utilized in the present disclosure. The mailbox depicted in FIGS. 3-8 is typical of one popular type of mailbox, but any other style, shape and size of mailbox is contemplated for use in the security system of the present disclosure.

### Connections and Securements

The mailbox and camera system and components can be joined in any operable configuration in any suitable manner. By way of example, component parts can be joined by adhesive, magnetic attraction, screwing, nailing, double-sided tape, hook and loop fasteners (e.g., VELCRO®), tying, pressure fit, and the like.

### Camera System Operation and Connectivity

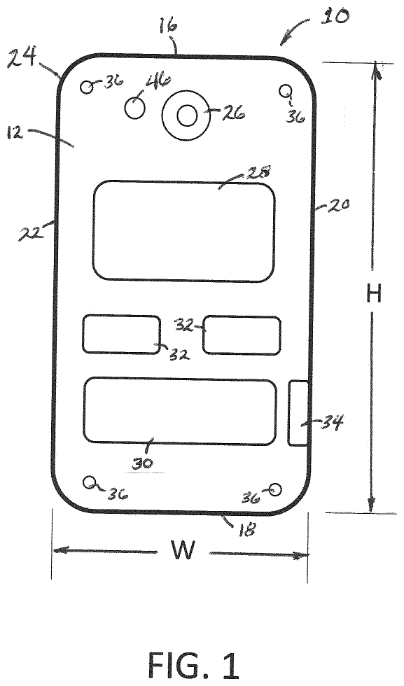

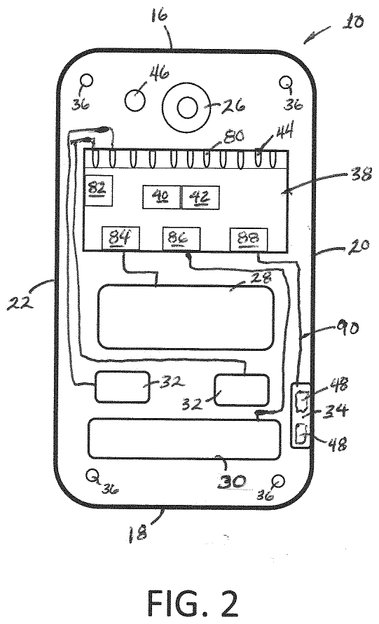

A camera system of the present disclosure can be an integrated unit as shown schematically in FIGS. 1 and 2. FIGS. 1 and 2 show representative examples of a camera system that can be operatively associated with a mailbox to achieve the benefit of better security for items deposited in mailboxes. As described below, the camera system can be mounted in, on, or near a mailbox or a mailbox support. For example, the camera system, or parts thereof, can be mounted directly on the front, back, side, top, or bottom of a mailbox such that the camera field of view captures the external vicinity of the mailbox in its field of view. In an embodiment, the camera system, or parts thereof, can be mounted on the front of the mailbox, secured to the outside face of the door facing toward a street, for example. Other representative embodiments are described below.

As depicted in FIG. 1, a camera system 10 can be generally rectangular shaped having a front face 12, a rear face 14 (not shown), a top side 16, a bottom side 18, a right side (as viewed in the depiction of FIG. 1) 20 and a left side (as viewed in the depiction of FIG. 1) 22 that form an outer housing 24 of the camera system 10. The outer housing 24 can be made of impact-resistant injection molded plastic and can be weather resistant or weather proof.

The shape and size of the camera system 10 can be varied as desired for design criteria. In general, the camera system 10 can have a maximum dimension of between about 0.5 inch and about 24 inches. In an embodiment, the camera system outer housing can be generally rectangular-shaped having a height H of between about 2 inches and about 10 inches, a width W of between about 1 inch and about 6 inches, and a depth D (not shown, but the dimension into the page as the camera system is shown in FIG. 1) of between about 0.1 inch to about 3 inches.

The camera system can include various operational components, including without limitation those indicated in FIG. 1, including a camera 26, a display screen 28 which can be a touchscreen, one or more speakers 28, one or more motion sensors 32, a battery compartment 34, and mounting means, such as tabs, slots, or one or more holes 36 as shown in FIG. 1. Each of the various components can be interconnected and operationally associated by means known in the art for cameras, displays, motion sensors, speakers and power supplies, including batteries.

Referring now to FIG. 2, a portion of certain internal components of the camera system 10 are depicted. As shown, a circuit board 38, which can be referred to as a motherboard, can have a plurality of circuits and pins 80 for external connections to operatively connected components. Circuit board 38 can have integrated thereon non-transient memory components 40 with, for example, RAM memory storage, and a CPU processor 42 that can have programmable memory for controlling the other various components, such as the camera 26, display 28, which can be a touchscreen display, speaker(s) 30, motion sensors 32, and connector pins 44. Further, the circuit board can include an SD card port 82, a video input/output port 84, an audio input/output port 86, and a power connection 88, which may be to battery power or to line voltage. The circuit board 38 can be encased within a metal weatherproof casing or a polymeric weatherproof coating.

In operation, the motion sensor(s) 32 can detect motion in a vicinity of a mailbox. The range of motion, such as the distance and radius of coverage of the motion sensor(s) can be adjusted by input to a settings menu on the display 28, or remotely via a mobile device app wirelessly operatively connected to the camera system. Once a motion detector 32 detects movement in the vicinity of the mailbox, signals from the motion detector 32 can be processed by the CPU and can facilitate the camera operation to begin recording image capture, including video imaging, sending the image capture data to the circuit board 38 where it can be processed, stored in RAM, or streamed to a connected device, such as a connected mobile device. In conjunction with image capture, a microphone 46 associated with the camera system 10 can capture audio, including ambient audible sounds.

The speaker(s) can be connected to the circuit board 38 and can facilitate audible signals from the camera system 10. For example, a recorded voice message can be started upon activation of a motion sensor. Alternatively, a real-time voice from a user connected via a remote mobile device can be activated. Alternatively, an alarm can sound through speaker(s) 30.

As depicted in FIG. 2, the various internal components of camera system 10 can be connected by circuitry 90, which can include wires and/or circuit board traces, lands, pads, and pins, to the circuit board, which can be powered by a battery 48 inside battery compartment 34. Alternatively, power can be supplied from an AC or DC power source, such a line voltage from existing power sources, including, for example, 120-Volt AC power sources. In embodiments, the camera system components can include a transformer to transform line voltage to operating voltage for circuit board 38 and other components, as necessary.

Referring now to FIG. 3, there is shown an embodiment of a mailbox and camera system 100 in operable configuration. In the illustrated example, a mailbox 50 can be mounted on a pole or post 52 that can be secured to the ground 54. The mailbox 50 can have a door 56 hingedly attached thereto, with the door 56 having an internal surface 58 (internal when the door is closed). The mailbox 50 defines an interior portion 60 into which items such as mail 62 can be deposited. A flag 64 can indicate the presence of mail 62 in the mailbox 50. A camera system 10, as described above, can be mounted onto the post 52 and oriented such that a person accessing the interior portion 60 of mailbox 50 would be in the field of detection of the motion sensor(s) 30 and/or the field of view of the camera 26.

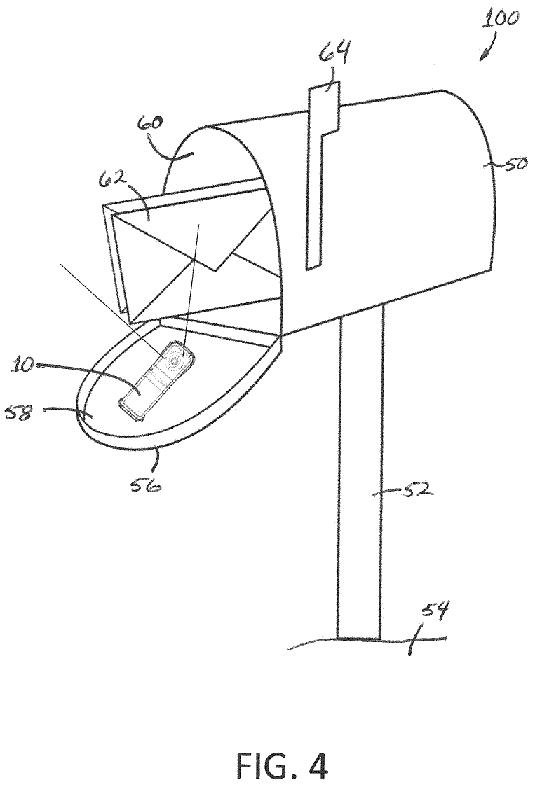

Another non-limiting embodiment is shown in FIG. 4, in which the camera system 10 is mounted to the internal surface 58 of door 56. In this embodiment, upon opening the door 56 motion sensor(s) 30 can detect motion (either motion external to the sensor, such as persons or things outside of mailbox 50, or motion detected internally, such as by accelerometers integrated in motion sensor(s) 30) and camera 26 and/or speaker(s) 32 can be activated by executable instructions from the CPU.

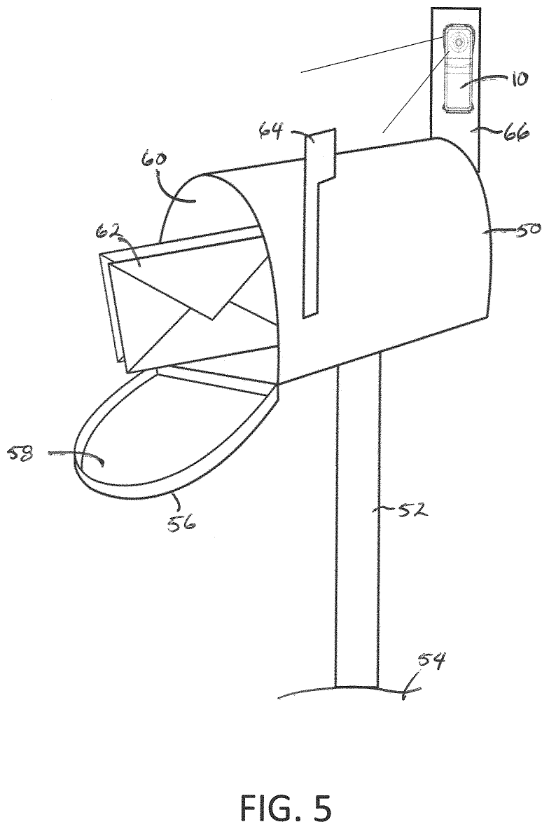

Another non-limiting embodiment is shown in FIG. 5, in which the camera system 10 is mounted external to the mailbox 50 directly. In this embodiment, a camera system 10, as described above, can be mounted onto a bracket 66 that can be mounted onto mailbox 50 and oriented such that a person accessing the interior portion 60 of mailbox 50 would be in the field of detection of the motion sensor(s) 30 and the field of view of the camera 26. Bracket mounting can be by bolting, adhering, welding, or the like.

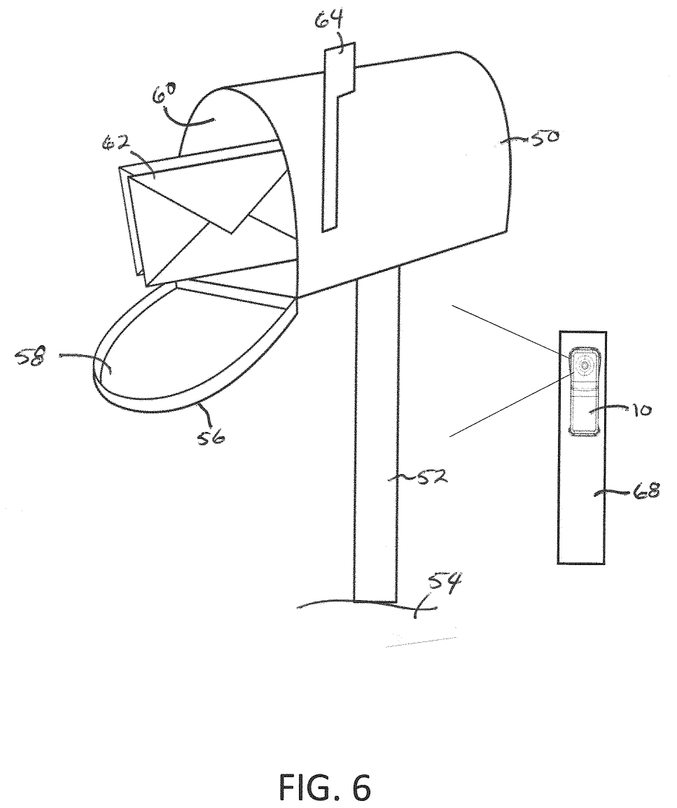

Another non-limiting embodiment is shown in FIG. 6, in which the camera system 10 is mounted external to and remotely from the mailbox 50. In this embodiment, a camera system 10, as described above, can be mounted onto a support 68 that is not connected to mailbox 50. Camera system can be oriented such that a person accessing the interior portion 60 of mailbox 50 would be in the field of detection of the motion sensor(s) 30 and the field of view of the camera 26. Support 68 can be disposed anywhere in operational vicinity to the mailbox 50, and can be, for example, ground-mounted, wall-mounted, gate-mounted, roof-mounted, and the like.

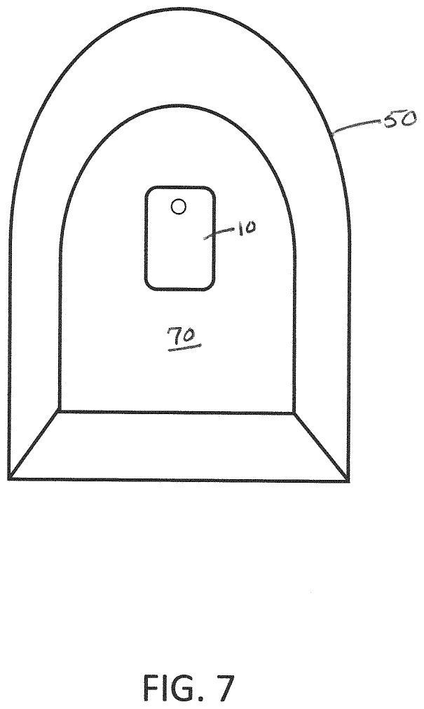

Another non-limiting embodiment is shown in FIG. 7, in which the camera system 10 is mounted internal to the mailbox 50 directly. In this embodiment, a camera system 10, as described above, can be mounted onto an internal surface of mailbox 50 and oriented such that a person accessing the interior portion 60 of mailbox 50 would be in the field of detection of the motion sensor(s) 30 and the field of view of the camera 26. As shown in FIG. 7, which is a view inside through the open door of a representative mailbox as depicted in FIG. 3, a camera system can be mounted on a vertically-oriented back wall 70.

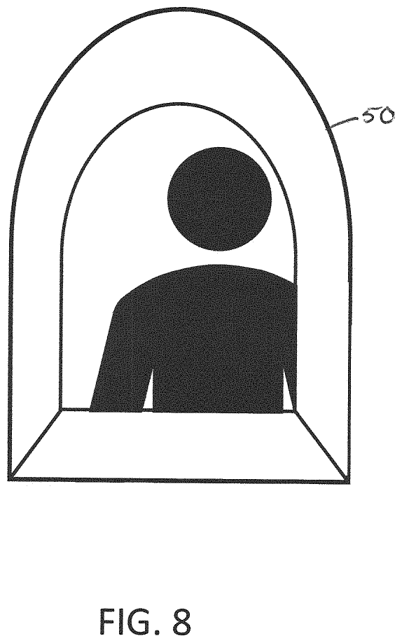

FIG. 8 depicts a representative view of a camera mounted as described above with respect to FIG. 7. As shown, the camera can capture images (and a microphone sounds) outside of mailbox 50, including identifying characteristics of a person accessing items inside mailbox 50.

A user can use the display to program various options for use, including the regulation of motion sensors, the regulation of the camera, the regulation of the speaker, and the regulation of the an alarm. For example, motions sensors can be programmed to detect motion within a certain time of day, within a certain distance, and within a certain radial range. The camera can be programmed to capture still images or video, in black and white or in color, and in slow, regular, or high speed. The speaker and or alarm can be programmed with a predetermined response upon detection of motion, including a voice announcement that the items in the mailbox are being surveilled.

Likewise, the above-mentioned programming tasks can be achieved via the use of a remote computing device wired or wirelessly connected to the camera system. In like manner as using the a touchscreen display on the camera device, a remote computing device such as a Smartphone connected via Wi-Fi or Bluetooth to the CPU of the camera system can be utilized for all programming and all monitoring of the camera system.

An “app” on a Smartphone can be utilized to interact with the camera system for set-up, programming, monitoring, and downloading captured image data. The Smartphone can be wirelessly configured via Wi-Fi or Bluetooth, for example, to achieve connectivity. In an embodiment, the camera system can be wirelessly connected to a router that can then be accessed via the Internet for secure remote accessibility via a remote computing device.

Once the motion sensor(s) detects motion programmed executable instructions in the processor can instruct the camera to begin image capture. The resulting images, either still and/or video, can be recorded in the RAM memory and stored.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

What is claimed is:

1. A mailbox security system, the system comprising:
a. a mailbox, the mailbox having an open end and a closed end, the closed end comprising a vertically oriented face, and
b. a camera system, the camera system comprising a camera being mounted on the vertically oriented face and oriented for image capture at the open end of the mailbox, and
c. the camera system further comprising a touchscreen display, at least one motion sensor for detecting movement outside the open end of the mailbox and non-transient memory for storing images upon the detection and image capture of the movement, and wireless transmission components for wirelessly transmitting the recorded images to a mobile device.
